(19) United States
(12) Patent Application Publication
(10) Pub. No.: US 2004/0183634 A1
(43) Pub. Date: Sep. 23, 2004

(54) Electromagnetic relay

(76) Inventors: Seiichiro Kobayashi, Tottori City (JP); Tomohiro Maeta, Tottori City (JP)

Correspondence Address: HARNESS, DICKEY & PIERCE, P.L.C., P.O. BOX 8910, RESTON, VA, 20195, US

(21) Appl. No.: 10/677,327

(22) Filed: Oct. 3, 2003

(30) Foreign Application Priority Data
Mar. 19, 2003 (JP) 2003-075044

(51) Int. Cl. H01H 67/02

(52) U.S. Cl. 335/128

(57) ABSTRACT

An electromagnetic relay includes a first electromagnetic block provided with a movable contact, a normally open contact and a normally closed contact, and a second electromagnetic block provided with at least a movable contact and a normally open contact, both the first electromagnetic block and the second electromagnetic block being placed in a single case, wherein the normally closed contact of the first electromagnetic block is connected to the movable contact of the second electromagnetic block within the case.

### CROSS-REFERENCE TO RELATED APPLICATION

This application is related to Japanese application No.2003-075044 filed on Mar. 19, 2003, whose priority is claimed under 35 USC § 119, the disclosure of which is incorporated by reference in its entirety.

### BACKGROUND OF THE INVENTION

1. Field of the Invention

The present invention relates to an electromagnetic relay in which a plurality of electromagnetic blocks are all placed in a case.

2. Description of the Background Art

As disclosed in Japanese Unexamined Patent Publication NO. 2003-59383, for example, a plurality of electromagnetic blocks are housed in a case composed of a base block 2 and a cover B with the intention of downsizing electrical devices and the high-density mounting and cost-reduction thereof.

In the above construction, the electromagnetic blocks of almost the same specification each provided with a fixed contact, a normally open contact and a normally closed contact are arranged separately so as to allow connection outside the cover B. Therefore, exclusive control of a plurality of loads by the electromagnetic blocks requires a normally closed contact 71 of one electromagnetic block 70 to be connected to a movable contact 73 of another electromagnetic block 72 by means of a trace 74 of a printed pattern on a circuit board, i.e., outside the cover B, and also requires loads 76 and 77 which are to be exclusively controlled to be connected to a normally open contact 75 of the electromagnetic block 70 and a normally open contact 78 of the electromagnetic block 72, respectively. See FIG. 5, for example.

Because of this construction, if the loads 76 and 77 receive large load current as in the case of heaters for ovens, the trace 74 of the printed pattern for connection is required to be located at a large distance from adjacent trances of the pattern. That prevents the high-density mounting of the circuit board.

### SUMMARY OF THE INVENTION

The present invention is intended to enable exclusive control of a plurality of loads by a single relay provided with a plurality of electromagnetic blocks with a view to high-density mounting of circuit boards.

The present invention provides an electromagnetic relay including a first electromagnetic block provided with a movable contact, a normally open contact and a normally closed contact, and a second electromagnetic block provided with at least a movable contact and a normally open contact, both the first and second electromagnetic blocks being placed in a single case, wherein the normally closed contact of the first electromagnetic block is connected to the movable contact of the second electromagnetic block within the case.

According to the present invention, in suitable places of the case, there are provided a first connecting terminal connected to the movable contact of the first electromagnetic block, a second connecting terminal connected to the normally opened contact of the first electromagnetic block, and a third connecting terminal connected to the normally open contact of the second electromagnetic block. The first connecting terminal is connected to one terminal of a power source, the second connecting terminal is connected to another terminal of the power source with intervention of a first load and the third connecting terminal is connected to said another terminal of the power source with intervention of a second load. Thereby the first and second loads are exclusively controlled.

The present invention also provides an electromagnetic relay including at least a pair of electromagnetic blocks each provided with a movable contact, a normally open contact and a normally closed contact, both the electromagnetic blocks being placed in a single case, wherein the normally closed contact of one of the electromagnetic blocks is connected to the movable contact of other one of the electromagnetic blocks within the case.

According to the present invention, in suitable places of the case, there are provided a first connecting terminal connected to the movable contact of said one of the electromagnetic blocks, a second connecting terminal connected to the normally open contact of said one of the electromagnetic blocks, a third connecting terminal connected to the normally open contact of said other one of the electromagnetic blocks, and a fourth connecting terminal connected to the normally closed contact of said other one of the electromagnetic blocks. The first connecting terminal is connected to one terminal of a power source, the second connecting terminal is connected to another terminal of the power source with intervention of a first load and the third connecting terminal is connected to said another terminal of the power source with intervention of a second load. Thereby the first and second loads are exclusively controlled.

Further, according to the present invention, the third connecting terminal is connected to a movable contact of an electromagnetic relay provided with a normally open contact, the normally open contact of this electromagnetic relay is connected to said another terminal of the power source with intervention of a third load. Thereby the first, second and third loads are exclusively controlled.

### BRIEF DESCRIPTION OF THE DRAWINGS

FIG. 1 is a circuit diagram of an example of an electromagnetic relay in accordance with the present invention;

FIG. 2 is a circuit diagram showing an example of the use of the electromagnetic relay of FIG. 1;

FIG. 3 is a circuit diagram of another example of an electromagnetic relay in accordance with the present invention;

FIG. 4 is a circuit diagram showing an example of the use of the electromagnetic relay of FIG. 3; and

FIG. 5 is a circuit diagram of a conventional electromagnetic relay.

### DETAILED DESCRIPTION OF THE PREFERRED EMBODIMENT

The invention is now described in detail with reference to examples as shown in figures.

### Embodiment 1

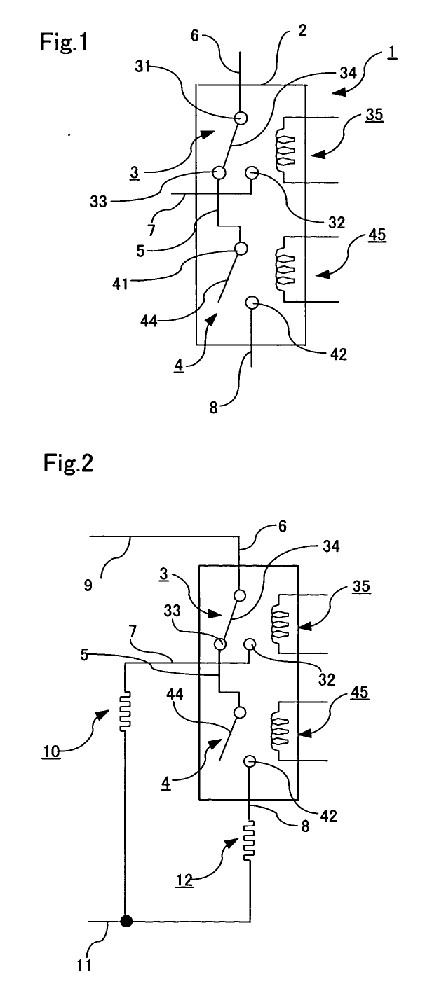

An electromagnetic relay 1 includes a first electromagnetic block 3 and a second magnetic block 4 both arranged in a case 2 as shown in FIG. 1.

The first electromagnetic block 3 is provided with a movable contact 31, a normally open contact 32 and a normally closed contact 33. The second electromagnetic block 4 is provided with a movable contact 41 and a normally open contact 42. Movable contact pieces 34 and 44 are pivoted on the movable contacts 31 and 41, respectively. Magnet coils 35 and 45 are provided adjacently to the movable contact pieces 34 and 44, respectively. When power is applied to the magnet coils 35 and 45, the tip of the movable contact piece 34 is switched from the normally closed contact 33 to the normally open contact 32 to connect to the latter and the movable contact piece 44 connects to the normally open contact 42.

The normally closed contact 33 of the first electromagnetic block 3 is connected to the movable contact 41 of the second electromagnetic block 4 by a connecting wire 5 within the case 2. The connecting wire 5 may be composed of any material in any shape so long as it can provide electrical connection, for example, an inner lead wire, a connecting hardware formed by a bent copper plate, a circuit pattern traces patterned on the substrate or the like.

At suitable places of the case 2, for example, at the bottom of the case, a first connecting terminal 6 connected to the movable contact 31, a second connecting terminal 7 connected to the normally open contact 32 of the first electromagnetic block 3 and a third connecting terminal 8 connected to the normally open contact 42 of the second electromagnetic block 4 are provided. The first, second and third connecting terminals 6, 7 and 8 are partially exposed outside the case, that is, these terminals project from the inside to the outside of the case 2.

Preferably, the case used in the invention is formed of a material capable of ensuring insulation such as plastic, for example, thermosetting resin, thermoplastic resin or the like. Specific examples include acrylic resin, epoxy resin, acrylate resin, urethane resin, silicone resin, polyimide resin, polycarbonate resin, polynorbornene resin, polyamide resin, fluoroplastic and the like.

Preferably, the connecting wire 5, regardless of its material, is entirely or partially embedded in or covered with the above-mentioned resin for ensured insulation. For example, the connecting wire 5 may be embedded or covered except where it is connected to other components.

According to the above-described construction, as shown in FIG. 2, for example, by connecting the first connecting terminal 6 to one terminal 9 of commercial power, connecting the second connecting terminal 7 to another terminal 11 of the commercial power with intervention of a roasting heater 10 and connecting the third connecting terminal 8 to said another terminal 11 of the commercial power with intervention of a oven heater 12, it is possible to control exclusive connection of the roasting heater 10 and the oven heater 12.

For example, power can be applied only to the roasting heater 10 via the movable contact piece 34 and the normally open contact 32 by applying power to the magnet coil 35 to connect the movable contact piece 34 to the normally open contact 32. On the other hand, power can be applied only to the oven heater 12 via the movable contact piece 44 and the normally open contact 42 by stopping power application to the magnet coil 35 and applying power to the magnet coil 45 to connect the movable contact piece 44 to the normally open contact 42.

### Embodiment 2

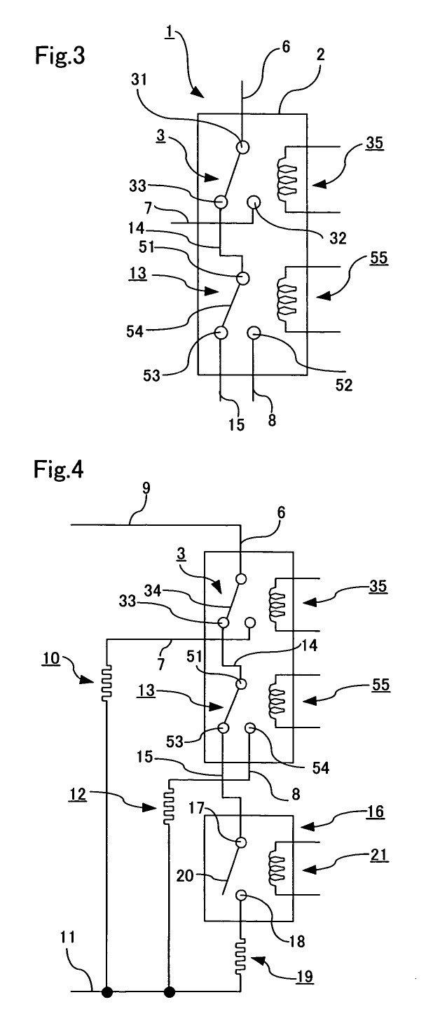

FIG. 3 illustrates another example of the invention, in which the same reference numerals denote the same components as in the above-described example.

In FIG. 3, an electromagnetic relay 1 is constructed to include a first electromagnetic block 3 as described above and a third electromagnetic block 13 both arranged in a case 2.

The third electromagnetic block 13 is provided with a movable contact 51, a normally open contact 52 and a normally closed contact 53. A movable contact piece 54 is pivoted on the movable contact 51. A magnet coil 55 is provided adjacently to the movable contact piece 54. When power is applied to the magnet coil 55, the tip of the movable contact piece 54 is switched from the normally closed contact 53 to the normally open contact 52. to connect to the latter

The normally closed contact 33 of the first electromagnetic block 3 is connected to the movable contact 51 of the third electromagnetic block 13 by a connecting wire 14 within the case 2. The connecting wire 14 may be composed of any material in any shape so long as it can provide electrical connection as the above-described.

Also at suitable places of the case 2, for example, at the bottom of the case, a first connecting terminal 6 connected to the movable contact 31 of the first electromagnetic block 3, a second connecting terminal 7 connected to the normally open contact 32 thereof, a third connecting terminal 8 connected to the normally open contact 52 of the third electromagnetic block 13 and a fourth connecting terminal 15 connected to the normally closed contact 53 thereof are provided. The first, second, third and fourth connecting terminals 6, 7, 8 and 15 project from the inside to the outside of the case 2.

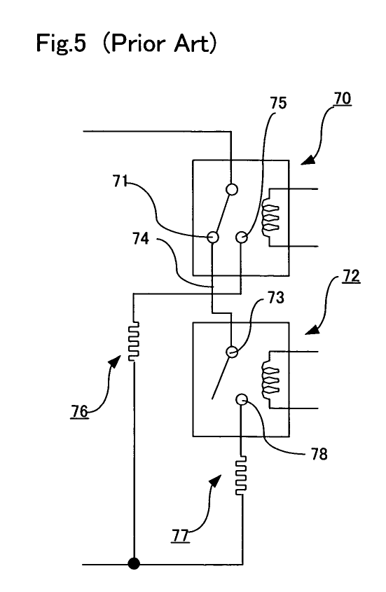

FIG. 4 shows an example of a circuit diagram illustrating how said another example of the invention is used.

A roasting heater 10, an oven heater 12 and a hot-air heater 19 can each be exclusively supplied with power and selectively controlled by connecting the first connecting terminal 6 to one terminal 9 of commercial power, connecting the second connecting terminal 7 to another terminal 11 of the commercial power with intervention of the roasting heater 10, connecting the third connecting terminal 8 to said another terminal 11 of the commercial power with intervention of the oven heater 12, connecting the fourth connecting terminal 15 to a movable contact 17 of an electromagnetic relay 16 and connecting a normally open contact 18 of the electromagnetic relay 16 to said another terminal 11 of the commercial power with intervention of the hot-air heater 19.

A movable contact piece 20 is pivoted on the movable contact 17 of the electromagnetic relay 16 and a magnet coil 21 is provided adjacently to the movable contact piece 20. By applying power to the magnet coil 21, the movable contact piece 20 is connected to the normally open contact 18, and thereby, the hot-air heater 19 is supplied with power via the movable contact 34 of the first electromagnetic block 3, the normally closed contact 33 thereof, the connecting wire 14, the movable contact piece 54 of the third electromagnetic block 13, the normally closed contact 53 thereof, the fourth connecting terminal 15, the movable contact piece 20 of the electromagnetic relay 16 and the normally open contact 18 thereof.

The above-described connection of the loads is only an example for the purpose of illustration and should not be construed to limit the scope of the invention. For example, a plurality of loads can be connected to each of the connecting terminals.

With the construction of the invention, for using a plurality of relays (electromagnetic blocks), especially for exclusively controlling a plurality of loads by the relays, the single case includes the first electromagnetic block provided with the movable contact, the normally open contact and the normally closed contact and the second electromagnetic block provided with at least the movable contact and the normally open contact and the normally closed contact of the first electromagnetic block is connected to the movable contact of the second electromagnetic block within the case. Thereby the relays (electromagnetic blocks), as a whole, can be used as a single circuit component, and connecting lines for connecting the contacts of the relays outside the case are no longer required. That reduces the number of circuit components, and allows high-density mounting of components and also allows a decreased number of production steps. Consequently, production costs reduces.

Further, with the construction of the invention, by connecting the movable contact of the first electromagnetic block to one terminal of a power source and connecting the normally open contact of the first electromagnetic block and the normally open contact of the second electromagnetic block to another terminal of the power source via loads, the application of power to the loads can be exclusively controlled. Thereby, even in the case of a heater and the like to which a lot of power needs to be supplied, the need to enlarge the distance between traces of a printed pattern formed on a circuit board is eliminated. That allows high-density mounting on the circuit board.

Also, with the construction of the invention, wherein the single case includes at least a pair of electromagnetic blocks each provided with the movable contact, the normally open contact and the normally closed contact and the normally closed contact of one of the electromagnetic blocks is connected to the movable contact of other one of the electromagnetic blocks by the connecting wire within the case, the relays (electromagnetic blocks), as a whole, can be used as a single circuit component, and connecting lines for connecting the contacts of the relays outside the case are no longer required. That reduces the number of circuit components, and allows high-density mounting of components and also allows a decreased number of production steps. Consequently, production costs reduces.

Further, with the construction of the invention, by connecting the movable contact of one of the electromagnetic blocks to one terminal of a power source and connecting the normally open contact of said one of the electromagnetic blocks and the normally open contact of other one of the electromagnetic blocks to another terminal of the power source via loads, the application of power to at least these two loads can be exclusively controlled. Thereby, even in the case of a heater and the like to which a lot of power needs to be supplied, the need to enlarge the distance between traces of a printed pattern formed thereon is eliminated. That allows high-density mounting on a circuit board.

Furthermore, according to the invention, the application of power to three loads can be exclusively controlled with a relatively simple construction wherein a movable contact of an additional electromagnetic relay having a normally open contact is connected to the normally closed contact of said other one of the electromagnetic blocks and the normally open contact of the additional electromagnetic relay is connected to said other terminal of the power source via a load. That allows high-density mounting on a circuit board and also allows cost reduction by decreasing the number of components and production steps.

Particularly, according to the present invention, the connecting wires are partially or entirely embedded in or covered with the material of the case. Thus, insulation can be ensured by a smaller area and the relay can be reduced in size.

What is claimed is:

1. An electromagnetic relay comprising:
a first electromagnetic block provided with a movable contact, a normally open contact and a normally closed contact, and
a second electromagnetic block provided with at least a movable contact and a normally open contact,
both the first electromagnetic block and the second electromagnetic block being placed in a single case,
wherein the normally closed contact of the first electromagnetic block is connected to the movable contact of the second electromagnetic block within the case.

2. The electromagnetic relay according to claim 1 further comprising:
a first connecting terminal connected to the movable contact of the first electromagnetic block,
a second connecting terminal connected to the normally open contact of the first electromagnetic block, and
a third connecting terminal connected to the normally open contact of the second electromagnetic block,
the first connecting terminal, the second connecting terminal and the third connecting terminal being partially exposed outside the case,
wherein the first connecting terminal is connected to one terminal of a power source, the second connecting terminal is connected to another terminal of the power source with intervention of a first load and the third connecting terminal is connected to said another terminal of the power source with intervention of a second load, for exclusively controlling the first load and the second load.

3. The electromagnetic relay according to claim 1, wherein the normally closed contact of the first electromagnetic block is connected to the movable contact of the second electromagnetic block by a connecting wire.

4. The electromagnetic relay according to claim 3, wherein the case is formed of an insulating material and the connecting wire is partially or entirely embedded in or covered with the insulating material.

5. An electromagnetic relay comprising:
at least a pair of electromagnetic blocks each provided with a movable contact, a normally open contact and a normally closed contact, both the electromagnetic blocks being placed in a single case,
wherein the normally closed contact of one of the electromagnetic blocks is connected to the movable contact of other one of the electromagnetic blocks by a connecting wire within the case.

6. The electromagnetic relay according to claim 4 further comprising:
a first connecting terminal connected to the movable contact of said one of the electromagnetic blocks,
a second connecting terminal connected to the normally open contact of said one of the electromagnetic blocks,
a third connecting terminal connected to the normally open contact of said other one of the electromagnetic blocks, and
a fourth connecting terminal connected to the normally closed contact of said other one of the electromagnetic blocks,
the first connecting terminal, the second connecting terminal, the third connecting terminal and the fourth connecting terminal being partially exposed outside the case,
wherein the first connecting terminal is connected to one terminal of a power source, the second connecting terminal is connected to another terminal of the power source with intervention of a first load and the third connecting terminal is connected to said another terminal of the power source with intervention of a second load, for exclusively controlling the first load and the second load.

7. The electromagnetic relay according to claim 5, wherein the third connecting terminal is connected to a movable contact of an electromagnetic relay provided with a normally open contact, the normally open contact of this electromagnetic relay is connected to said another terminal of the power source with intervention of a third load, for exclusively controlling the first load, the second load and the third load.

8. The electromagnetic relay according to claim 4, wherein the normally closed contact of the first electromagnetic block is connected to the movable contact of the second electromagnetic block by a connecting wire.

9. The electromagnetic relay according to claim 7, wherein the case is formed of an insulating material and the connecting wire is partially or entirely embedded in or covered with the insulating material.
